(19) United States
(12) Patent Application Publication
(10) Pub. No.: US 2019/0027861 A1
(43) Pub. Date: Jan. 24, 2019

(54) ELECTRONIC CONNECTORS WITH MAGNETIC COPPER ALLOYS

(71) Applicant: Materion Corporation, Mayfield Heights, OH (US)

(72) Inventors: Derrick L. Brown, Hamilton, CA (US); Fritz C. Grensing, Perrysburg, OH (US); Joseph G. Kaiser, Barrington, RI (US); Michael J. Gedeon, Mentor, OH (US); Amy E. Craft, Amherst, OH (US); Ryan C. Elliott, Cleveland, OH (US)

(21) Appl. No.: 16/039,820

(22) Filed: Jul. 19, 2018

Related U.S. Application Data
(60) Provisional application No. 62/534,771, filed on Jul. 20, 2017.
(60) Provisional application No. 62/534,756, filed on Jul. 20, 2017.

(51) Int. Cl. H01R 13/62; H01F 1/03

(52) U.S. Cl. CPC H01R 13/6205; H01R 43/00; H01F 1/0317

(57) ABSTRACT

Connectors including one or more electrical contacts and a magnetic portion are disclosed. The magnetic portion is made from a copper alloy comprising nickel, tin, manganese, and balance copper. In some embodiments, the electrical contact(s) are the magnetic portion. In other embodiments, the magnetic portion is a separate element from the electrical contact(s). Also disclosed are connectors for mating a host electronic device with an accessory which both include magnetic portions. Further described herein are methods for mating host electronic devices with an accessory using such connectors.

### CROSS-REFERENCE TO RELATED APPLICATIONS

This application claims priority to U.S. Provisional Patent Application Ser. No. 62/534,756, filed Jul. 20, 2017; and U.S. Provisional Patent Application Ser. No. 62/534,771, filed Jul. 20, 2017, each of which is fully incorporated by reference herein.

### BACKGROUND

The present disclosure relates to connectors which utilize magnetic copper-based alloys, in particular electrical or electronic connectors utilizing copper-nickel-tin-manganese alloys. Also disclosed are electronic devices that incorporate such connectors; methods of making such connectors; and methods of using such connectors.

Ergonomic regulations limit the amount of insertion force that can be used to mate electrical and electronic connectors. However, high withdrawal forces are desired to ensure connector reliability. This tends to increase the insertion/mating force, and as a result, the number of discrete contacts that can be placed in any connector can be limited. In addition, counterfeit and fraudulently manufactured connectors which do not meet stringent standards set by original equipment manufacturers within a given ecosystem are often produced and sold. Such connectors present problems of reliability and safety for electronic devices within the ecosystem.

It would be desirable to provide devices and methods which can maintain a reduced insertion force but increase the withdrawal force of electronic connectors. It would also be desirable to provide additional means for improving device security or preventing counterfeiting of OEM approved accessories.

### BRIEF DESCRIPTION

The present disclosure is directed to electronic connectors and electrical contacts which include magnetic copper alloys, particularly copper-nickel-tin-manganese alloys. The magnetic properties of the copper alloys can be obtained by processing the alloy under certain conditions. As a result, magnetism can be used to increase the withdrawal force and maintain connector reliability without dramatically increasing the insertion or mating force needed for connectors that use such magnetic copper alloys. The resulting magnetism can alternatively or additionally be used to identify whether the connector is OEM approved, and/or whether a secure connection has been made. The connector should be simple and cost effective, with no need for tracking approved devices using supporting software.

In accordance with one aspect of the present disclosure, a connector is disclosed. The connector includes a body, one or more electrical contacts on the body, and at least one electrical contact also includes a magnetic portion. The magnetic portion is made from a copper alloy comprising nickel, tin, manganese, and balance copper. The electrical contacts can be formed from the copper alloy. The connector can be a plug connector or a receptacle connector.

In accordance with another aspect of the present disclosure, methods for making an electrical connector are disclosed. A copper alloy is placed on a body, the copper alloy comprising nickel, tin, manganese, and balance copper. The copper alloy is then heat treated to convert the copper alloy into a magnetic copper alloy. The copper alloy forms a portion of at least one electrical contact. The heat treatment can be by homogenization, aging, or solution annealing.

Also disclosed herein are electronic devices comprising a connector, wherein the connector includes a copper alloy comprising nickel, tin, manganese, and balance copper. The copper alloy forms at least a portion of at least one electrical contact on the connector.

Also disclosed are methods of mating a host electronic device with an accessory, comprising: inserting a plug connector of the accessory into a receptacle connector of the host electronic device, wherein the receptacle connector and the plug connector each include a magnetic portion that attract each other, such that the withdrawal force is increased; and wherein at least one of the magnetic portions is part of an electrical contact and is made from a copper alloy comprising nickel, tin, manganese, and balance copper. Magnetism between the two magnetic forces increases the withdrawal force compared to the insertion force. One or both magnetic portions can be formed from the magnetic copper alloy. If desired, the other magnetic portion can be an electromagnet or a permanent magnet.

In accordance with a related aspect of the present disclosure, a connector is disclosed. The connector includes a body and at least one magnetic portion on the body. The magnetic portion is made from a copper alloy comprising nickel, tin, manganese, and balance copper. The magnetic portion(s) can be placed in various locations on the body, and can be made by various methods, such as inlay cladding, heat treatment, and welding.

In accordance with another aspect of the present disclosure, methods for making an electrical connector are disclosed. A copper alloy is placed on a body, the copper alloy comprising nickel, tin, manganese, and balance copper. The copper alloy is then heat treated to convert the copper alloy into a magnetic copper alloy. The heat treatment can be by homogenization, aging, or solution annealing. Electrical contacts are formed on the body, either before or after the magnetic portion is formed by heat treatment.

Also disclosed herein are electronic devices comprising a connector, wherein the connector includes a magnetic portion formed from a copper alloy comprising nickel, tin, manganese, and balance copper. The magnetic portion is not an electrical contact on the connector.

Also disclosed are systems comprising an accessory and a host electronic device. The accessory has a plug connector, wherein the connector includes at least one magnetic portion, wherein the at least one magnetic portion is made from a copper alloy comprising nickel, tin, manganese, and balance copper. The host electronic device has a receptacle connector, the receptacle connector including a magnetic sensor adapted to sense the magnetic portion of the accessory. In this manner, the host electronic device can determine whether the accessory is a counterfeit or is approved for use with the host electronic device.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1A illustrates a host electronic device and an accessory, each including a connector having one or more electrical contacts according to an embodiment of the present disclosure.

FIG. 1B illustrates a host electronic device and an accessory, each including a connector having one or more electrical contacts and connected via a separate cable according to one aspect of the present exemplary embodiment.

FIG. 2 illustrates a receptacle connector and a plug connector, each having one or more electrical contacts. Here, both sets of electrical contacts are made from the magnetic copper alloy.

FIG. 3 illustrates a receptacle connector and a plug connector, each having one or more electrical contacts. Here, the electrical contacts of the plug connector interact with a magnet within the receptacle connector.

FIG. 4 illustrates a connector having at least one magnetic portion added by inlay cladding. Two different materials are combined to form a composite body. As illustrated here, one magnetic portion is located at a first end, proximate a first side. The other magnetic portion is located at a second end opposite the first end, and proximate a second side opposite the first side.

FIG. 5 illustrates a connector having one or more magnetic portions formed by a heat treatment of the body. The body is formed from a single material.

FIG. 6 illustrates a connector having a magnetic portion at one end of the connector.

FIG. 7 illustrates a receptacle connector and a plug connector. The plug connector has a magnetic portion, and the receptacle connector has a magnetic sensor for detecting a property of the magnetic portion.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

The present disclosure may refer to temperatures for certain process steps. It is noted that these generally refer to the temperature at which the heat source (e.g. furnace) is set, and do not necessarily refer to the temperature which must be attained by the material being exposed to the heat.

The present disclosure relates to electrical connectors that are a component of electronic devices. The term “connector” as used herein generally describes a body which includes electrical contacts on an exterior surface of the body. An exterior surface is any surface that can be directly contacted by a second body during normal use and operation.

The electrical connectors include at least one magnetic portion that generates a magnetic field. In particular embodiments, at least one of the electrical contacts includes the magnetic portion. The magnetic portion is made from a magnetic copper alloy. The electrical contacts are thus both magnetic and electrically conductive. In other embodiments, the magnetic portion is not an electrical contact, but rather a separate element or part within the body of the electrical connector. Regardless of the location of the magnetic portion within the electrical connector, it is contemplated that this magnetic field will increase the withdrawal force while not affecting the insertion force of the connectors. It is also contemplated that a property of the magnetic portion can be used by an electronic device to determine whether the connector (or any device of which the connector is a component) is secure or OEM approved. Such properties may include the location of the magnetic portion on the connector, the strength of any magnetic field or electrical current generated by the magnetic portion as determined by a magnetic sensor, or another magnetic property. The magnetic portion does not need to be connected to any electrical circuit in order to function for this purpose. More than one magnetic portion may be present in the electrical connector (i.e. multiple elements or parts are present, not only a single magnetic portion).

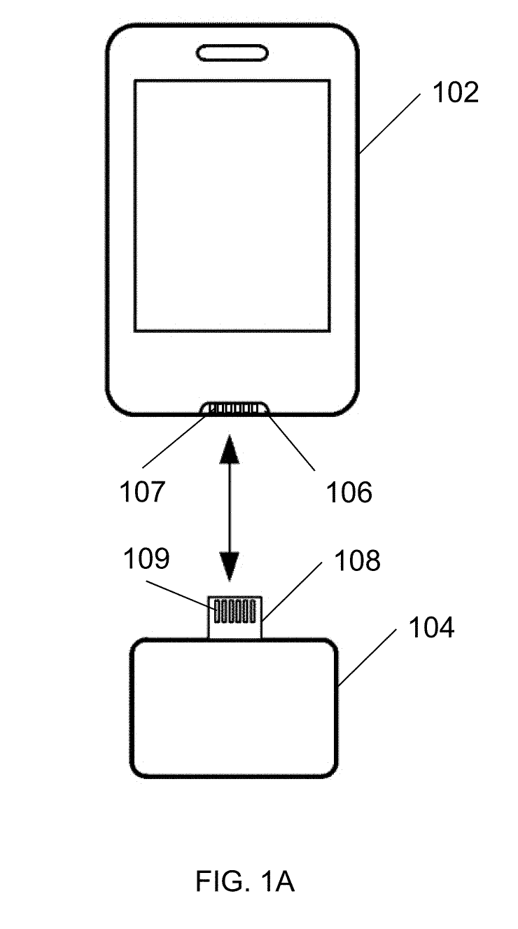

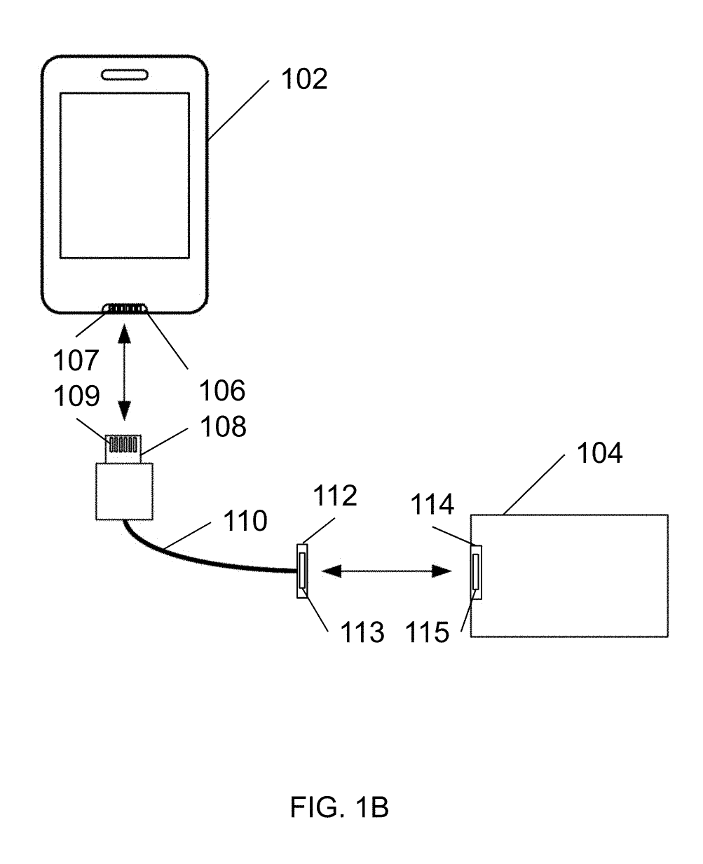

FIG. 1A illustrates a host electronic device 102 and an external accessory 104. Host electronic device 102 includes a receptacle connector 106 that can be used to connect host electronic device 102 with an external accessory, e.g., accessory 104. Accessory 104 includes a complementary plug connector 108 that can be mated with the connector 106 of host electronic device 102. The receptacle connector 106 includes a plurality of first electrical contacts 107 adapted to contact a corresponding plurality of second electrical contacts 109 on the plug connector 108. Connector 108 can be incorporated directly into accessory 104, as illustrated in FIG. 1A.

Alternatively, connector 108 can be part of a cable 110 that includes a second plug connector 112 that can be connected to accessory 104 via a second receptacle connector 114 incorporated into accessory 104, e.g., as illustrated in FIG. 1B. Connector pair 112, 114 may be the same type of connector pair as connectors 106, 108 or may be a different type of connector pair that is physically and/or electrically incompatible with connectors 112, 114. Moreover, connector pair 112, 114 may include a respective plurality of first and second electrical contacts 113, 115 adapted to maintain contact with each other. In embodiments where connector pair 112, 114 is incompatible with connector pair 106, 108, circuitry (not shown) can be included in one or of connectors 112, 114 to convert signals received through pair 112, 114 to a format that can be used by connector pair 106, 108.

Host electronic device 102 can be a digital media player; a mobile communication device; a portable computing device; a laptop computer, a desktop computer or other electronic device. Moreover, host electronic device 102 can provide media player capability, networking, web browsing, e-mail, word processing, data storage, application execution, and/or any other computing or communication functions.

External accessory 104 can be any device capable of communicating with host electronic device 102 such as, e.g., a charger cable, an external speaker system, an external video device, a multimedia device, a consumer electronic device, a test instrument, a home appliance (e.g., refrigerator or dishwasher), exercise equipment, a security system, a home or office automation system, a camera, a user input device (e.g., keyboard, mouse, game controller), a measurement device, a medical device (e.g., glucose monitor or insulin monitor), a point of sale device, an automobile, an automobile accessory (e.g., a car stereo system or car navigation system), a radio (e.g., FM, AM and/or satellite), an entertainment console on an airplane, bus, train, or other mass transportation vehicle, etc. Any type of device that can be used in conjunction with a user device can be used as an accessory device.

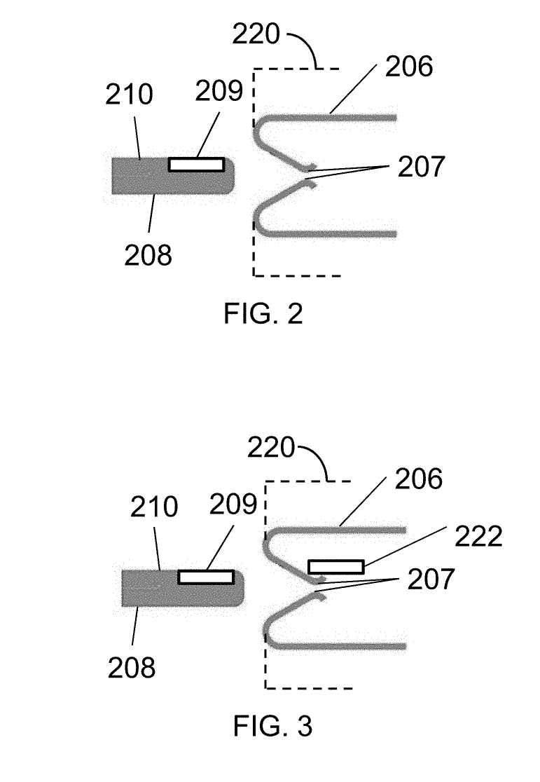

FIG. 2 illustrates an exemplary connector according to one embodiment of the present disclosure. A female or receptacle connector 206 is illustrated in FIG. 2 and may be included in a host electronic device, such as host electronic device 102 illustrated in FIG. 1A and FIG. 1B. The receptacle connector includes a body 220, illustrated here in dotted lines. Receptacle connector 206 also includes one or more electrical contacts 207 on the body 220.

A male or plug connector 208 is also shown which may be included in an external accessory, such as external accessory 104 illustrated in FIG. 1A and FIG. 1B. The plug connector 208 includes a body 210 and also includes one or more electrical contacts 209 located proximate to a front portion of the body, and along a first surface of the body. As illustrated in FIG. 2, receptacle electrical contacts 207 have a spring beam construction. The plug connector 208 has a blade or pin construction, with electrical contacts 209 having an embedded plate construction. The plug connector 208 makes contact with the spring contacts 207 inside the receptacle connector 206. As the plug 208 is inserted, it will slide across and deflect the spring beams 207 until the beams contact the plates 209. This generates the mating force necessary for good electrical contact, and also generates a retention force necessary for retaining the plug within the receptacle. Once the beams 209 are fully deflected and are touching only the flat contacts 209 of the pin, the normal force will be perpendicular to the insertion direction. The withdrawal force then will simply be equal to the normal force multiplied by the coefficient of sliding friction and the number of contact points.

In order to improve retention force and increase the withdrawal force, electrical contacts 207 and 209 can be provided as high strength magnetic portions/elements. In particular, the electrical contacts 207, 209 can include the magnetic copper alloys disclosed herein to provide a high strength electrical contact with an attractive force between the receptacle connector 206 and the plug connector 208. As the plug 208 is inserted into the receptacle 206, the attractive magnetic force between the electrical contacts 207, 209 will draw the contacts toward each other, thereby reducing the insertion force required to mate the plug with the receptacle. The attractive magnetic force between the electrical contacts 207, 209 after insertion of the plug connector 208 with the receptacle connector 206 will also increase the retention force between the two elements. The attractive force between the contacts 207, 209 also aids in maintaining a strong electrically conductive relationship between the contacts. As illustrated in FIG. 2, both sets of electrical contacts 207 and 209 are made from a magnetic copper alloy (as described further herein).

FIG. 3 illustrates another contemplated embodiment. Here, the plug connector 208 includes a body 210 with electrical contacts 209 that are made from the magnetic copper alloy. However, the body 220 of the receptacle connector 206 contains a separate magnet 222 that is located to attract the electrical contacts 207 of the plug connector 208. Put another way, the electrical contacts 207 are not made of the magnetic copper alloy, and are only electrically conductive.

As desired, the separate magnet 222 could alternatively be an electromagnet or a permanent magnet. The magnetic field of an electromagnet is generated when electricity is run through the electromagnet. A permanent magnet generates a persistent magnetic field. The locations of the magnetic elements can also be reversed, i.e. the separate magnet is located in the plug connector 208 and the magnetic electrical contacts are located in the receptacle connector 206.

The magnetic copper alloy may be used monolithically, or may be used as part of a composite material. For example, the entire electrical contact 207 and/or 209 can be made from the magnetic copper alloy, or only a portion or section of the electrical contact 207, 209 can be made from the magnetic copper alloy.

In any event, the magnetic portion advantageously provides inherent magnetic attraction force to help maintain plug connector 208 in the mated position with receptacle connector 206, without having to dramatically increase insertion force. This can occur regardless of where the magnetic portion is located (either as an electrical contact or as a separate element within the electrical connector). Furthermore, the connectors which include the copper alloys of the present disclosure can advantageously be fabricated by any means used for standard copper alloy contacts. The use of these known fabrication techniques is made possible by the ability to activate the alloy's magnetic properties after the connector has been formed. For example and as discussed in further detail below, the magnetic properties can be “turned on” or reactivated by heat treatment processes performed after the connector is formed. Suitable fabrication techniques include stamping, photochemical machining, etc., and the like.

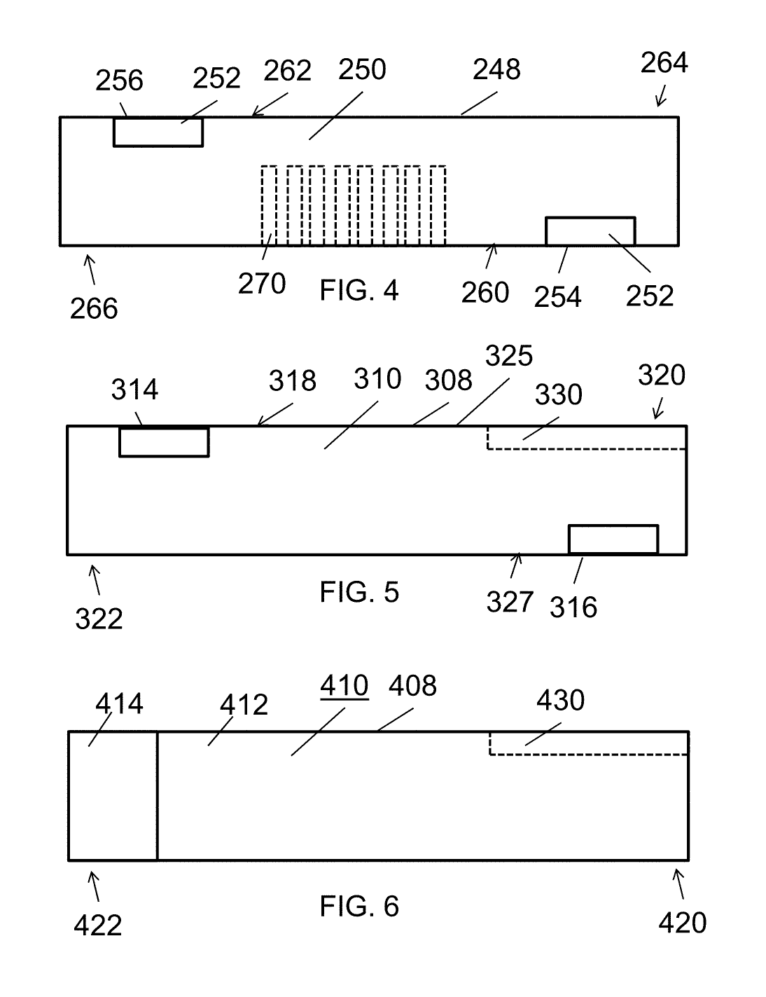

FIG. 4 is a plan view of an exemplary plug connector 248 according to an embodiment of the present disclosure. The male or plug connector 248 may be included in an external accessory, such as external accessory 104 illustrated in FIGS. 1A and 1B. The plug connector 248 can mate with a female or receptacle connector 106 or 114 as shown in FIG. 1A or FIG. 1B.

As shown in FIG. 4, the connector 248 includes a body 250 and (as illustrated here) two different magnetic portions 252. The body and magnetic portions are made of different materials, and have been combined to form a composite strip. The body 250 of the connector 248 can be made from any standard material known as being useful for electronic connectors. The magnetic portions 252 are made from a magnetic copper alloy and have specific magnetic properties useful to the application for which the connector 248 is used. In the embodiment illustrated in FIG. 4, electrical contacts 270 are located at a first end 260 of the body. A second end 262 is opposite the first end. The body also has a first side 264 and a second side 266 opposite the first side. A first magnetic portion 254 is located at the first end 260 and is also proximate the first side 264. A second magnetic portion 256 is located at the second end 262, and is also proximate the second side 266. Magnetic sections 254 and 256 are illustrated as being located on opposing ends and sides of the connector 248, but such locations are only exemplary, and the magnetic sections can be provided at any desired location on the connector.

Here, the body 250 and the magnetic portions 252 are made from different materials. For example, the body 250 of the connector 248 can be made of a standard copper-nickel-tin alloy, while magnetic portions 252 are made from a magnetic copper-nickel-tin-manganese alloy. These two alloys are difficult to distinguish visually, which also increases security and the difficulty of counterfeiting the connector.

Magnetic portions 254 and 256 can be added to the connector 248 by a skiving process followed by inlay cladding. In particular, skiving is first performed on the base material 250 of the connector 248 to form a groove at desired locations. The groove is then filled with cladding material, which in this case is the magnetic copper alloys described herein. Mechanical bonding of the copper alloy cladding to the connector is accomplished by any suitable means known to those having skill in the art, such as passing the materials through pressure rolls of a bonding mill. As discussed in further detail below, the magnetic properties of the copper alloy inlays can be provided as-cast, or alternatively, magnetic properties can be activated through subsequent heat treatment.

FIG. 5 illustrates a side cross-sectional view of an exemplary plug connector 308 according to an alternative embodiment of the present disclosure. Here, the connector 308 is made from a single material, such as the copper alloys described in further detail below. Thus, the body 310 and the magnetic portions 314, 316 are made from a copper-nickel-tin-manganese alloy. The magnetic portions 314, 316 are portions of the body 310 that have been heat treated to become magnetic, as described here. The remainder of the body remains non-magnetic. The body has a first end 320 and a second end 322 opposite the first end. The body also has a first surface 325 and a second surface 327 opposite the first surface. Electrical contacts 330 are present at the first end 320 on the first surface 325. A first magnetic portion 314 is located on first surface 325 at second end 322 of the plug connector 308. A second magnetic portion 316 is located at second surface 327 on first end 320 of the plug connector. Again, these locations are exemplary.

The magnetic properties of portions 314 and 316 of connector 308 can be activated or “turned on” by a heat treatment. For example, laser annealing can be performed at desired locations to activate the magnetic properties of the copper alloy.

FIG. 6 illustrates another exemplary embodiment of a plug connector 408. The body 410 of the connector 408 is made from two different material portions 412, 414 which have been combined to form a composite strip. The magnetic portion 414 has been incorporated or heat treated to obtain desired magnetic properties useful to the application for which connector 408 may be used. Here, electrical contacts 430 are present at a first end 420 of the connector, and the magnetic portion 412 is located at the second end 422 of the connector 408.

The connectors 208, 308, and 408 illustrated in FIGS. 2-4 incorporate the copper alloys of the present disclosure to advantageously provide magnetic properties to a connector, usually of an accessory 104 as illustrated in FIG. 1A and FIG. 1B. The host electronic device can incorporate magnetic/electric sensors that will be able to determine if there is a secure connection with the connector, or if the accessory to which the connector belongs has an OEM approved connection. Using standard technologies such as laser annealing, E-beam welding, cladding, or even thin film deposition, the magnetic copper alloys disclosed herein can be added to standard materials and connectors designs to develop this added functionality.

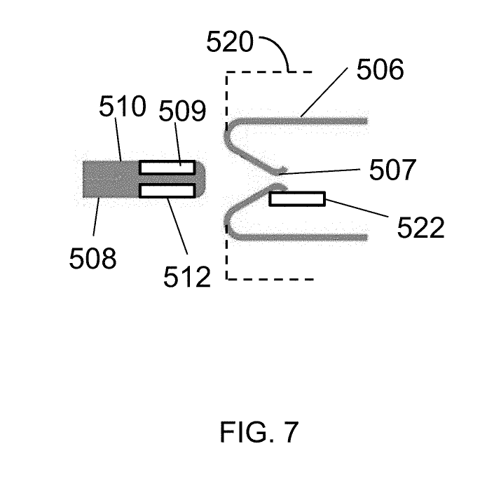

FIG. 7 illustrates the interaction of the connector with the host electronic device. Here, the connector 508 is a plug connector that includes a body 510 with electrical contacts 509 and a magnetic portion 512 that is separate from the electrical contacts. As illustrated here, the electrical contacts 509 are on a first surface of the body, while the magnetic portion 512 is on an opposite second surface of the body. The host electronic device 520 includes a receptacle connector 506 that contains complementary electrical contacts 507. A magnetic sensor 522 is located so as to be able to interrogate the magnetic portion 512 of the plug connector 508. The host electronic device is thus able to use the magnetic portion to determine the status of the connector (i.e. approved or not approved).

The use of the presently disclosed magnetic copper alloys in the connectors described herein (whether in the electrical contact or elsewhere) can also further improve security and reduce counterfeiting by management of the supply chain. In this regard, the copper alloy raw material is difficult to reverse engineer, preventing would-be counterfeiters from being able to produce fraudulent counterfeit devices unless the raw material is secured from an approved and monitored source. Additionally, in embodiments wherein the body of the connector and the magnetic portion(s) of the connector are made from similar materials (e.g., a standard copper-nickel-tin alloy such as ToughMet™, and a copper-nickel-tin-manganese magnetic alloy), the two materials would be nearly impossible to discern, further reducing the ability to counterfeit the connector. Furthermore, as described in further detail below, specific copper alloys/magnetic tempers can be developed for each OEM if required or advantageous, thereby preventing cross-use between OEMs. In addition, use of the disclosed copper alloys has the further advantage of being mainly composed of copper, which permits a high scrap value. Finally, existing technologies rely on expensive software (e.g., tracking software in host electronic devices which track counterfeit devices) and/or hardware (e.g., specialized chips added to the connector) to prevent counterfeit devices from working with or even damaging a host electronic device. The connectors containing the magnetic copper alloys described herein present a comparatively cheaper, simpler, and more cost-effective option for the host electronic device (e.g., magnetic sensor) to achieve the same security as expensive software and/or hardware.

As discussed previously, the connectors described herein include one or more magnetic portions made of a copper alloy, such as copper-nickel-tin-manganese (Cu—Ni—Sn—Mn) alloys. The nickel may be present in the copper-nickel-tin-manganese alloys in an amount of from about 8 wt % to about 16 wt %. In more specific embodiments, the nickel is present in amounts of about 14 wt % to about 16 wt %, about 8 wt % to about 10 wt %, or about 10 wt % to about 12 wt %. The tin may be present in an amount of from about 5 wt % to about 9 wt %. In more specific embodiments, the tin is present in amounts of about 7 wt % to about 9 wt %, or about 5 wt % to about 7 wt %. The manganese may be present in an amount of from about 1 wt % to about 21 wt %, or from about 1.9 wt % to about 20 wt %. In more specific embodiments, the manganese is present in amounts of at least 4 wt %, at least 5 wt %, about 4 wt % to about 12 wt %, about 5 wt % to about 21 wt %, or about 19 wt % to about 21 wt %. The balance of the alloy is copper.

The alloys may further include one or more other additives such as chromium, silicon, molybdenum, or zinc, or iron, magnesium, manganese, niobium, tantalum, vanadium, zirconium, or aluminum in minor amounts, or may contain impurities. For purposes of this disclosure, each such element or impurity can be present in an amount of less than 0.3 wt %, and the total amount of all such additives and impurities should be less than 1.0 wt %.

In some specific embodiments, the magnetic portion of the connectors are made of a copper-nickel-tin-manganese alloy that contains from about 8 wt % to about 16 wt % nickel, about 5 wt % to about 9 wt % tin, about 1 wt % to about 21 wt % manganese, and balance copper.

In other specific embodiments, the connectors include a magnetic portion made of a copper-nickel-tin-manganese alloy that contains from about 8 wt % to about 16 wt % nickel, about 5 wt % to about 9 wt % tin, about 5 wt % to about 21 wt % manganese, and balance copper.

In different embodiments, the connectors include a magnetic portion made of a the copper-nickel-tin-manganese alloy that contains from about 8 wt % to about 16 wt % nickel, about 5 wt % to about 9 wt % tin, about 5 wt % to about 11 wt % manganese, and balance copper.

In yet additional embodiments, the connectors include a magnetic portion made of a copper-nickel-tin-manganese alloy that contains from about 14 wt % to about 16 wt % nickel, about 5 wt % to about 9 wt % tin, about 5 wt % to about 11 wt % manganese, and balance copper.

In more specific embodiments, the connectors include a magnetic portion made of a the copper-nickel-tin-manganese alloy that contains from about 14 wt % to about 16 wt % nickel, about 7 wt % to about 9 wt % tin, about 1 wt % to about 21 wt % manganese, and balance copper.

In more specific embodiments, the connectors include a magnetic portion made of a copper-nickel-tin-manganese alloy that contains from about 14 wt % to about 16 wt % nickel, about 7 wt % to about 9 wt % tin, about 4 wt % to about 12 wt % manganese, and balance copper.

In other specific embodiments, the connectors include a magnetic portion made of a copper-nickel-tin-manganese alloy that contains from about 8 wt % to about 10 wt % nickel, about 5 wt % to about 7 wt % tin, about 1 wt % to about 21 wt % manganese, and balance copper.

In other specific embodiments, the connectors include a magnetic portion made of a copper-nickel-tin-manganese alloy that contains from about 8 wt % to about 10 wt % nickel, about 5 wt % to about 7 wt % tin, about 4 wt % to about 21 wt % manganese, and balance copper.

In a few specific embodiments, the connectors include a magnetic portion made of a copper-nickel-tin-manganese alloy that contains from about 10 wt % to about 12 wt % nickel, about 5 wt % to about 7 wt % tin, about 1 wt % to about 21 wt % manganese, and balance copper.

The copper-nickel-tin-manganese alloys may be included in the connectors as either a monolithic magnetic portion or as part of a composite material. In other words, the magnetic portion of the connectors disclosed herein may be made entirely from the copper-nickel-tin-manganese alloy or from a different material which includes the copper-nickel-tin-manganese alloy.

The alloys included in the magnetic portion of connectors can be formed by the combination of solid copper, nickel, tin, and manganese in the desired proportions. The preparation of a properly proportioned batch of copper, nickel, tin, and manganese is followed by melting to form the alloy. Alternatively, nickel, tin, and manganese particles can be added to a molten copper bath. The melting may be carried out in a gas-fired, electrical induction, resistance, or arc furnace of a size matched to the desired solidified product configuration. Typically, the melting temperature is at least about 2057° F. with a superheat dependent on the casting process and in the range of 150 to 500° F. An inert atmosphere (e.g., including argon and/or carbon dioxide/monoxide) and/or the use of insulating protective covers (e.g., vermiculite, alumina, and/or graphite) may be utilized to maintain neutral or reducing conditions to protect oxidizable elements.

Reactive metals such as magnesium, calcium, beryllium, zirconium, and/or lithium may be added after initial meltdown to ensure low concentrations of dissolved oxygen. Casting of the alloy may be performed following melt temperature stabilization with appropriate superheat into continuous cast billets or shapes. In addition, casting may also be performed to produce ingots, semi-finished parts, near-net parts, shot, pre-alloyed powder, or other discrete forms which can be included with the magnetic portion of the connectors.

Alternatively, separate elemental powders can be thermomechanically combined to produce the copper-nickel-tin-manganese alloy for raw input materials, semi-finished parts, or near-net parts to be included with the magnetic portion of the connectors.

A thin film of the copper-nickel-tin-manganese alloy can also be produced for the magnetic portion of the connectors through standard thin film deposition techniques, including but not limited to sputtering or evaporation. The thin film can also be produced by co-sputtering from two or more elemental sputtering targets, or a combination of appropriate binary or ternary alloy sputtering targets, or from sputtering from a monolithic sputtering target that contains all four elements required to be fabricated to achieve the desired proportions in the film. It is acknowledged that specific heat treatment of the thin film may be required to develop and improve the magnetic and material properties of the film.

In some embodiments, the as-cast alloy included with the magnetic portion of the connectors is magnetic. In addition, the magnetic and mechanical properties of the as-cast alloy included with the magnetic portion of the connectors can be changed by additional processing steps. In addition, alloys that were previously magnetic after some processing steps can be rendered non-magnetic by further processing steps, then rendered magnetic again after additional processing. Advantageously, the magnetic properties of the alloy included with the magnetic portion of the connectors can be activated by further processing steps to the raw alloy material prior to fabrication of the connector or to the magnetic portion of the connector after it has been fabricated. The magnetic property is thus not necessarily inherent to the copper-based alloy itself, and is affected by the processing that is performed. As a result, one can obtain connectors which include magnetic alloys having desired combinations of magnetic and strength properties such as relative magnetic permeability, electrical conductivity, and hardness (e.g. Rockwell B or C). A customized magnetic response in the connectors can thus be tailored based on various combinations of homogenizing, solution annealing, aging, hot working, cold working, extrusion, and hot upsetting. In addition, such alloys should have a relatively low elastic modulus on the order of about 15×10⁶ psi to about 25×10⁶ psi. Thus, good spring characteristics can be achieved by enabling high elastic strains, on the order of 50% higher than otherwise expected from iron-based alloys or nickel-based alloys.

Homogenizing involves heating the alloy to create a homogeneous structure in the alloy to reduce chemical or metallurgical segregation that can occur as a natural result of solidification. Diffusion of the alloy elements occurs until they are evenly distributed throughout the alloy. This occurs at a temperature that is usually between 80% and 95% of the solidus temperature of the alloy. Homogenization improves plasticity, increases the consistency and the level of mechanical properties, and decreases anisotropy in the alloy.

Solution annealing involves heating a precipitation hardenable alloy to a high enough temperature to convert the microstructure into a single phase. A rapid quench to room temperature leaves the alloy in a supersaturated state that makes the alloy soft and ductile, helps regulate grain size, and prepares the alloy for aging. Subsequent heating of the supersaturated solid solution enables precipitation of the strengthening phase and hardens the alloy.

Age hardening is a heat treatment technique that produces ordering and fine particles (i.e. precipitates) of an impurity phase that impedes the movement of defects in a crystal lattice. This hardens the alloy.

Hot working is a metal forming process in which an alloy is passed through rolls, dies, or is forged to reduce the section of the alloy and to make the desired shape and dimension, at a temperature generally above the recrystallization temperature of the alloy. This generally reduces directionality in mechanical properties, and produces a new equiaxed microstructure, particularly after solution annealing. The degree of hot working performed is indicated in terms of % reduction in thickness, or % reduction in area, and is referred to in this disclosure as merely “% reduction”.

Cold working is a metal forming process typically performed near room temperature, in which an alloy is passed through rolls, dies, or is otherwise cold worked to reduce the section of the alloy and to make the section dimensions uniform. This increases the strength of the alloy. The degree of cold working performed is indicated in terms of % reduction in thickness, or % reduction in area, and is referred to in this disclosure as merely “% reduction”.

Extrusion is a hot working process in which the alloy of a certain cross-section is forced through a die with a smaller cross-section. This may produce an elongated grain structure in the direction of extrusion, depending on the temperature. The ratio of the final cross-sectional area to the original cross-sectional area can be used to indicate the degree of deformation.

Hot upsetting or upset forging is a process by which workpiece thickness is compressed by application of heat and pressure, which expands its cross section or otherwise changes its shape. This plastically deforms the alloy, and is generally performed above the recrystallization temperature. This improves mechanical properties, improves ductility, further homogenizes the alloy, and refines coarse grains. The percent reduction in thickness is used to indicate the degree of hot upsetting or upset forging performed.

After some heat treatments, the alloy must be cooled to room temperature. This can be done by water quenching, oil quenching, synthetic quenching, air cooling, or furnace cooling. The quench medium selection permits control of the rate of cooling.

In a first set of additional processing steps, after the alloy is cast, the alloy is homogenized for a time period of about 4 hours to about 16 hours at a temperature of about 1400° F. to about 1700° F., and then water quenched or air cooled. This set of steps generally retains magnetism in alloys that have a manganese content of at least 5 wt %, decreases the relative magnetic permeability, can increase the electrical conductivity, and can change the hardness in either direction as desired. Alloys having a lower manganese content generally become non-magnetic upon this set of additional processing steps.

In some alloys, although the first set of additional processing steps removes magnetism, the magnetism can be regained upon a second homogenizing for a time period of about 8 hours to about 12 hours at a temperature of about 1500° F. to about 1600° F. and then water quenching. In some embodiments, the re-activation of magnetism by this second homogenizing step is performed to the raw alloy prior to fabrication of the connectors. In other embodiments, the magnetic properties are reactivated in the magnetic portion of the connector after fabrication.

Magnetism can also be retained if, after the homogenizing for a time period of about 4 hours to about 16 hours at a temperature of about 1400° F. to about 1700° F., the alloy is hot upset from about 40% to about 60% reduction, and then water quenched.

In a second set of additional processing steps, after the alloy is cast, the alloy is homogenized for a time period of about 5 hours to about 7 hours at a temperature of about 1500° F. to about 1700° F., and then air cooled. This set of steps can retain magnetism in alloys that have a manganese content of at least 5 wt %, particularly a manganese content of about 10 wt % to about 12 wt %.

Interestingly, the magnetism of some copper alloys that are rendered non-magnetic by the homogenizing step of the second set of additional steps can be made magnetic again by subsequently solution annealing the homogenized alloy for a time period of about 1 hour to about 3 hours at a temperature of about 1400° F. to about 1600° F. and then water quenching; aging the annealed alloy for a time period of about 2 hours to about 4 hours at a temperature of about 750° F. to about 1200° F., and then air cooling. Again, this processing can decrease the relative magnetic permeability, can increase the electrical conductivity, and can change the hardness in either direction as desired. In particular embodiments, the electrical conductivity is increased to about 4% IACS. In some embodiments, the re-activation of magnetism by the subsequent solution annealing, water quenching, aging, and air cooling is performed on the raw alloy prior to fabrication of the connectors. In other embodiments, the magnetic properties are reactivated by the subsequent solution annealing, water quenching, aging, and air cooling in the magnetic portion of the connector after fabrication.

In a third set of additional processing steps, after the alloy is cast, the alloy is homogenized for a time period of about 5 hours to about 7 hours at a first temperature of about 1500° F. to about 1700° F. and then air cooled. The alloy is then heated for a time period of about 1 hour to about 3 hours at a temperature of about 1400° F. to about 1600° F. (which is usually lower than the homogenization temperature), then hot rolled a first time. If needed, the alloy is reheated for a time period of about 5 minutes to about 60 minutes or more depending upon section size at a temperature of about 1400° F. to about 1600° F., and then hot rolled a second time to achieve a total reduction of about 65% to about 70%. Finally, the alloy is solution annealed for a time period of about 4 hours to about 6 hours at a temperature of about 1400° F. to about 1600° F.; and then cooled by either furnace cooling or water quenching. This set of steps can retain magnetism in alloys that have a manganese content of at least 5 wt %, as well as those having a manganese content of about 4 wt % to about 6 wt %.

After the homogenizing, hot rolling, and solution annealing described in the third set of additional processing steps, the alloy can also be aged for a time period of about 1 hour to about 24 hours at a temperature of about 750° F. to about 850° F. and then air cooled, and still remain magnetic.

In a fourth set of additional processing steps, after the alloy is cast, the alloy is homogenized for a time period of about 4 hours to about 22 hours at a temperature of about 1200° F. to about 1700° F. The alloy is then heated for a time period of about 1 hour to about 3 hours at a temperature of about 1400° F. to about 1600° F., and then is hot rolled to achieve a reduction of about 65% to about 70%. The alloy is then solution annealed for a time period of about 1 hour to about 3 hours at a temperature of about 1200° F. to about 1600° F. and then water quenched. Copper-nickel-tin-manganese alloys having a manganese content of at least 5 wt % can also retain their magnetism after this fourth set of processing steps, particularly those with a manganese content of about 7 wt % to about 21 wt %, or those having a nickel content of about 8 wt % to about 12 wt % and a tin content of about 5 wt % to about 7 wt %.

After the homogenizing, hot rolling, and solution annealing described in the fourth set of additional processing steps, the alloy can also be aged for a time period of about 2 hours to about 4 hours at a temperature of about 750° F. to about 1200° F. and then air cooled, and retain magnetism. This aging step can also re-activate the magnetism of some alloys that are non-magnetic after the homogenizing, hot rolling, and solution annealing processing steps. This aging step can also be performed on the raw alloy material prior to fabrication of the connector or to the magnetic portion of the connector after it has been fabricated. The combination of the fourth set of additional processing steps with this extra aging step can be considered a fifth set of additional processing steps.

Alternatively, after the homogenizing, hot rolling, and solution annealing described in the fourth set of additional processing steps, the alloy can also be cold rolled to achieve a reduction of about 20% to about 40%, and re-activate magnetism. Magnetism can be re-activated prior to or after connector fabrication. The combination of the fourth set of additional processing steps with this extra cold rolling step can be considered a sixth set of additional processing steps.

Additionally, after the homogenizing, hot rolling, solution annealing, and cold rolling described in the sixth set of additional processing steps, the alloy can then be aged for a time period of about 2 hours to about 4 hours at a temperature of about 750° F. to about 1200° F., and then air cooled, and re-activate magnetism as well. Again, Magnetism can be re-activated prior to or after connector fabrication. The combination of the sixth set of additional processing steps with this extra aging step can be considered a seventh set of additional processing steps.

In an eighth set of additional processing steps, after the alloy is cast, the alloy is homogenized for a time period of about 5 hours to about 7 hours, or about 9 hours to 11 hours, or about 18 hours to about 22 hours at a first temperature of about 1200° F. to about 1700° F. and then air cooled. The alloy is then heated for a second time period of about 4 hours or longer, including about 6 hours or longer, at a temperature of about 1200° F. to about 1600° F. The alloy is then extruded to achieve a reduction of about 66% to about 90%. Copper-nickel-tin-manganese alloys having a manganese content of at least 7 wt % can also retain their magnetism after this eighth set of processing steps, particularly those with a manganese content of about 10 wt % to about 12 wt %.

After the homogenizing and extruding steps described in the eighth set of additional processing steps, the alloy can also be solution annealed for a time period of about 1 hour to about 3 hours at a temperature of about 1200° F. to about 1700° F. and then water quenched. Copper-nickel-tin-manganese alloys having a manganese content of at least 7 wt % can also retain their magnetism after this ninth set of processing steps, particularly those with a manganese content of about 10 wt % to about 12 wt %. This solution annealing step can also re-activate the magnetism of some alloys that are non-magnetic after the homogenizing and extruding steps. Magnetism can again be re-activated prior to or after connector fabrication. The combination of the eighth set of additional processing steps with this solution annealing step can be considered a ninth set of additional processing steps.

In a tenth set of processing steps, after the alloy is extruded according to the eighth set of processing steps, the alloy is solution annealed for a time period of about 1 hour to about 3 hours at a temperature of about 1200° F. to about 1700° F. The alloy can optionally then be cold worked to achieve a reduction of about 20% to about 40%. The alloy is then aged for a time period of about 1 hour to about 4 hours at a temperature of about 600° F. to about 1200° F. In more particular embodiments, the aging is performed at temperatures of about 700° F. to about 1100° F., or about 800° F. to about 950° F., and then air cooled.

The alloy can also be heat treated in a magnetic field to change its properties. The alloy is exposed to a magnetic field, and then heated (e.g. in a furnace, by an infrared lamp, or by a laser). The heat treatment in a magnetic field can be performed on the raw alloy prior to connector fabrication or on the magnetic portion of the connector itself after it has been fabricated. This can result in a change in magnetic properties of the alloy, and can be considered an eleventh set of additional processing steps.

The resulting magnetic copper-nickel-tin-manganese alloys can thus have different combinations of values for various properties which may be desirable for various electronic connectors. The magnetic portion of the connectors may include a magnetic alloy with a relative magnetic permeability (μᵣ) of at least 1.100, or at least 1.500, or at least 1.900. The magnetic portion of the connectors may include a magnetic alloy having Rockwell hardness B (HRB) of at least 60, at least 70, or at least 80, or at least 90. The magnetic portion of the connectors may include a magnetic alloy having a Rockwell hardness C (HRC) of at least 25, at least 30, or at least 35. The magnetic portion of the connectors may include a magnetic alloy with a maximum magnetic moment at saturation (mₛ) of from about 0.4 emu to about 1.5 emu. The magnetic portion of the connectors may utilize a magnetic alloy having a remanence or residual magnetism (mᵣ) of from about 0.1 emu to about 0.6 emu. The magnetic portion of the connectors may use a magnetic alloy with a switching field distribution (ΔH/Hc) of from about 0.3 to about 1.0. The magnetic alloy included in the connectors may have a coercivity of from about 45 Oersteds to about 210 Oersteds, or of at least 100 Oersteds, or less than 100 Oersteds. The magnetic alloy included in the connectors may have a squareness, which is calculated as mᵣ/mₛ, of from about 0.1 to about 0.5. The connectors may include a magnetic alloy having a Sigma (mₛ/mass) of about 4.5 emu/g to about 9.5 emu/g. The magnetic portion of the connectors may utilize a magnetic alloy with an electrical conductivity (%IACS) of from about 1.5% to about 15%, or from about 5% to about 15%. The magnetic alloy included with the connectors may have a 0.2% offset yield strength of from about 20 ksi to about 140 ksi, including from about 80 ksi to about 140 ksi. The magnetic alloy utilized by the connectors may have an ultimate tensile strength of about 60 ksi to about 150 ksi, including from about 80 ksi to about 150 ksi. The magnetic portion of the connectors may include a magnetic alloy with a % elongation of about 4% to about 70%. The magnetic portion of the connectors may use a magnetic alloy having a CVN impact strength of at least 2 foot-pounds (ft-lbs) to in excess of 100 ft-lbs when measured according to ASTM E23, using a Charpy V-notch test at room temperature. The magnetic alloy included with the connectors may have a density of about 8 g/cc to about 9 g/cc. The connectors may include a magnetic alloy with an elastic modulus of about 16 million to about 21 million psi (95% confidence interval). Various combinations of these properties are contemplated.

In particular embodiments, the magnetic portion of the connectors may use a magnetic alloy having a relative magnetic permeability (μᵣ) of at least 1.100, and a Rockwell hardness B (HRB) of at least 60.

In other embodiments, the magnetic portion of the connector may include a magnetic alloy with a relative magnetic permeability (μᵣ) of at least 1.100, and a Rockwell hardness C (HRC) of at least 25.

In some embodiments, the copper-nickel-tin-manganese alloys included in the connectors may also contain cobalt. When cobalt is present, the alloy may contain from about 1 wt % to about 15 wt % cobalt.

Desirably, the connectors of the present disclosure include magnetic alloys to achieve a balance of mechanical strength, ductility, and magnetic behavior. The magnetic properties, such as magnetic attraction distance, coercivity, remanence, maximum magnetic moment at saturation, magnetic permeability, and hysteresis behavior, and the mechanical properties, can be tuned to the desired combinations.

It is believed that the magnetic copper alloys of the present disclosure are in a domain wherein the magnetism of the alloy will vary depending on the heat treatment and the composition of the alloy. In particular, intermetallic precipitates have been observed within the microstructure of some alloys. Thus, the alloys of the present disclosure can be considered as containing discrete dispersed phases within a copper matrix. Without being bound by theory, alternatively, the alloys can be described as Ni—Mn—Sn intermetallic compounds dispersed within a predominantly copper matrix that can also contain nickel and manganese.

In particular, it is contemplated that the magnetic portion of the connector can be formed after the copper alloy has undergone some portion of the processing needed to induce magnetism. Once the copper alloy has been applied to the connector body, the copper alloy can then be heat treated as needed to induce magnetism. The magnetic portion, (e.g. electrical contacts) can be formed, for example, by inserting a single piece of metal containing the magnetic copper alloy, then stamping the single piece to form multiple separate and distinct contacts. Alternatively, the magnetic portion can be completely processed to induce magnetism, then applied to the electrical connector body.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A connector, comprising:
a body; and
at least one magnetic portion on the body, wherein the magnetic portion is made from a copper alloy comprising nickel, tin, manganese, and balance copper.

2. The connector of claim 1, wherein the connector is a plug connector or a receptacle connector.

3. The connector of claim 1, having one or more electrical contacts on the body, wherein at least one of the electrical contacts includes the at least one magnetic portion.

4. The connector of claim 3, wherein the one or more electrical contacts have a spring beam construction or an embedded plate construction.

5. The connector of claim 3, wherein the one or more electrical contacts are fabricated by stamping or photochemical machining.

6. The connector of claim 1, wherein the body of the connector is made from a material that is different from the at least one magnetic portion.

7. The connector of claim 1, wherein the body of the connector is made from a non-magnetic copper alloy.

8. The connector of claim 1, wherein the at least one magnetic portion comprises a first magnetic portion located at a first end of the connector and a second magnetic portion located at a second end of the connector.

9. The connector of claim 8, wherein the first magnetic portion and the second magnetic portion are located on different surfaces of the connector.

10. The connector of claim 1, wherein the magnetic portion is monolithically formed from the magnetic copper alloy or is a composite material.

11. The connector of claim 1, wherein the magnetic copper alloy is magnetic in an as-cast form.

12. The connector of claim 1, wherein the alloy of the magnetic portion contains from about 8 wt % to about 16 wt % nickel, about 5 wt % to about 9 wt % tin, and from about 1 wt % to about 21 wt % manganese.

13. The connector of claim 1, wherein the alloy of the magnetic portion contains from about 14 wt % to about 16 wt % nickel, about 7 wt % to about 9 wt % tin, and from about 1 wt % to about 21 wt % manganese.

14. The connector of claim 1, wherein the alloy of the magnetic portion contains from about 8 wt % to about 10 wt % nickel, about 5 wt % to about 7 wt % tin, and from about 1 wt % to about 21 wt % manganese.

15. The connector of claim 1, wherein the alloy of the magnetic portion contains from about 10 wt % to about 12 wt % nickel, about 5 wt % to about 7 wt % tin, and from about 1 wt % to about 21 wt % manganese.

16. The connector of claim 1, wherein the magnetic portion is formed by placing the copper alloy in a non-magnetic form on the body and then heat treating to convert the non-magnetic copper alloy into a magnetic copper alloy.

17. A method for making an electrical connector, comprising:
placing a copper alloy on a body, the copper alloy comprising nickel, tin, manganese, and balance copper; and
heat treating the copper alloy to convert the copper alloy into a magnetic copper alloy.

18. The method of claim 17, wherein the magnetic copper alloy forms at least a portion of at least one electrical contact.

19. An electronic device comprising a connector, wherein the connector includes at least one magnetic portion formed from a copper alloy comprising nickel, tin, manganese, and balance copper.

20. The electronic device of claim 19, wherein the magnetic copper alloy forms at least a portion of at least one electrical contact.

21. The electronic device of claim 19, wherein the connector is a plug connector or a receptacle connector.

22. A method of mating a host electronic device with an accessory comprising:
inserting a plug connector of the accessory into a receptacle connector of the host electronic device, wherein the receptacle connector and the plug connector each include a magnetic portion that attract each other, such that the withdrawal force is increased;
wherein at least one of the magnetic portions is made from a copper alloy comprising nickel, tin, manganese, and balance copper.

23. The method of claim 22, wherein the at least one magnetic portion that is made from the copper alloy is part of an electrical contact.

24. A system comprising:
an accessory with a plug connector, wherein the connector includes at least one magnetic portion, wherein the at least one magnetic portion is made from a copper alloy comprising nickel, tin, manganese, and balance copper; and
a host electronic device with a receptacle connector, the receptacle connector including a magnetic sensor adapted to sense the magnetic portion of the accessory.
